(19) United States
(12) Patent Application Publication
(10) Pub. No.: US 2011/0191447 A1
(43) Pub. Date: Aug. 4, 2011

(54) CONTENT DISTRIBUTION SYSTEM

(75) Inventors: Alain Dazzi, San Jose, CA (US); Arun Krishnan, Cuppertino, CA (US)

(73) Assignee: CLARENDON FOUNDATION, INC., Murray, UT (US)

(21) Appl. No.: 13/015,122

(22) Filed: Jan. 27, 2011

Related U.S. Application Data
(60) Provisional application No. 61/299,520, filed on Jan. 29, 2010.

(51) Int. Cl. G06F 15/16

(52) U.S. Cl. 709/219

(57) ABSTRACT

A system for storing content available for streaming includes a storage tier with a plurality of storage clusters, each of the storage clusters having at least one server, the storage clusters collectively storing multiple media content files; a streaming tier coupled to the storage tier, the streaming tier having multiple streaming servers, the streaming tier being configured to stream data over a network faster than the storage tier is able to stream the data over the network; and a computer-implemented synchronization module configured to analyze traffic statistics associated with a media content file stored on the storage tier and selectively replicate the media content file on the streaming tier based on the traffic statistics.

### CROSS-REFERENCE TO RELATED PATENT APPLICATIONS

The present application claims priority under 35 U.S.C. §119(e) to U.S. Provisional Patent Application Ser. No. 61/299,520, which was filed on Jan. 29, 2010.

### TECHNICAL FIELD

The present disclosure relates generally to computers and computer-related technology. More specifically, the present disclosure relates to the storage and distribution of media content in a network for distributing content.

### BACKGROUND

Computer and communication technologies continue to advance at a rapid pace. Indeed, computer and communication technologies are involved in many aspects of a person's day. Computers commonly used include everything from hand-held computing devices to large multi-processor computer systems.

Content distribution networks (CDNs) provide media content (e.g. audio, video) streaming services to end users. Content providers desire their media content to be available to end users in a continuous playback environment and with minimal errors or buffer delays. However, traditional CDNs may only offer limited bandwidth.

### BRIEF DESCRIPTION OF THE DRAWINGS

FIG. 1 is diagram showing an illustrative traditional media content streaming system, according to one example of principles described herein.

FIG. 2 is a diagram showing an illustrative data storage structure for streaming media content, according to one example of principles described herein.

FIG. 3 is a block diagram illustrating a point of presence architecture including data storage structure for streaming media content, according to one example of principles described herein.

FIG. 4 is a block diagram illustrating a media storage configuration, according to one example of principles described herein.

FIG. 5 is a chart illustrating a media storage layout, according to one example of principles described herein.

FIG. 6 is a diagram showing an illustrative media content file placement on a data storage structure, according to one example of principles described herein.

FIG. 7 is a flowchart showing an illustrative method for storing media content on a data storage structure, according to one example of principles described herein.

FIG. 8 is a graphical illustration of the content latency vs. location, according to one example of principles described herein.

FIG. 9 illustrates the collection of traffic statistics, according to one example of principles described herein.

FIGS. 10A and 10B illustrate a content distribution module to be used with a disc array memory system and a storage server based system; respectively, according to various examples of principles described herein.

FIG. 11 is a block diagram illustrating a content distribution server design, according to one example of principles described herein.

Throughout the drawings, identical reference numbers designate similar, but not necessarily identical, elements.

### DETAILED DESCRIPTION

As described above, content distribution networks may be used to provide video streaming services to end users. A content distribution network is a group of computer systems working to cooperatively deliver content quickly and efficiently to end users over a network. End users are able to access a wide variety of content provided by various content producers. To compete for viewing time, content producers desire their media content to be available to end users with minimal delay and buffer error. Accomplishing this requires collaboration from a variety of networking equipment and storage systems. Such equipment and systems are often only capable of providing a limited bandwidth to end users. As a result, media content is often compressed using algorithms to reduce the amount of data required for streaming. However, media content can only be compressed to a certain extent. Thus, it is desirable to develop efficient structures and collaboration mechanisms which will provide media content to end users at a faster rate. Providing more media content data at a faster rate may enable the media content to be viewed by an end user at a higher quality and with fewer buffering delays.

The present specification relates to a data storage structure which provides mechanisms for increasing the efficiency at which media content may be streamed to end users. According to one illustrative example, a system for storing content available for streaming includes a storage tier communicatively connected to the archive tier, the storage tier including a plurality of storage clusters comprising at least one server, the storage clusters collectively storing a plurality of media files; a streaming tier communicatively connected to the storage tier, the streaming tier including a plurality of streaming servers configured to stream data over a network faster than the storage tier is able to stream the same data over the network; and a computer-implemented data distribution module configured to analyze traffic statistics associated with the media content to selectively replicate media content stored on the storage tier onto the streaming tier based on the traffic statistics.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

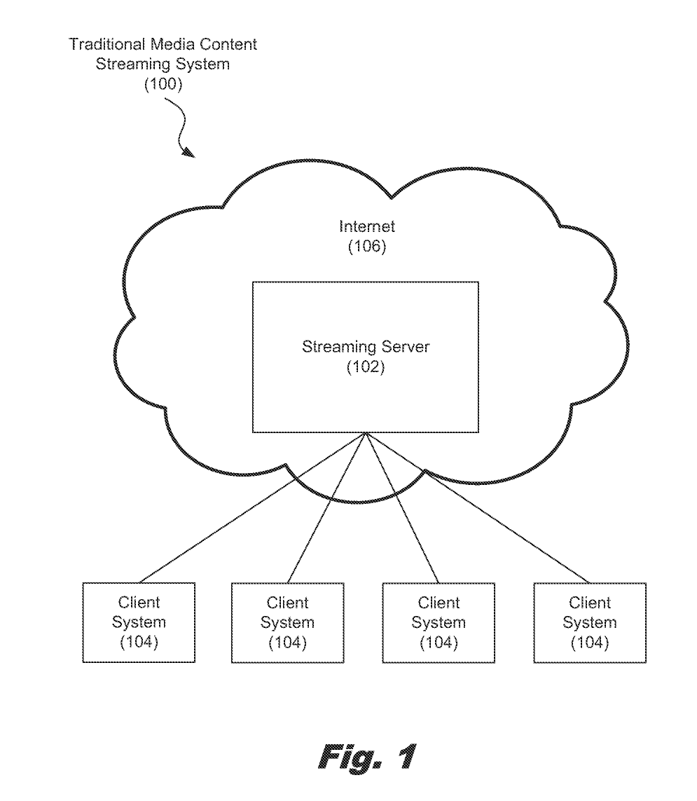

Referring now to the figures, FIG. 1 is diagram showing an illustrative traditional media content streaming system (100), according to the prior art. As illustrated, a traditional media content streaming system (100) may include a streaming server (102) associated with a network such as the Internet (106). The streaming server (102) contains media content available for streaming to client systems (104) requesting data contained in the streaming server (102). According to this prior art embodiment, the client systems (104) may request content from the streaming server (102). Once the request is received by the streaming server (102), the content is served to the requesting client system (104) using available server resources. Though this approach works well in some cases, the streaming server is limited in the amount of data it can stream. Thus, if too many client systems (104) are requesting media content streams from the streaming server (102), the quality of the streaming may be reduced or additional client systems (104) will not be allowed access.

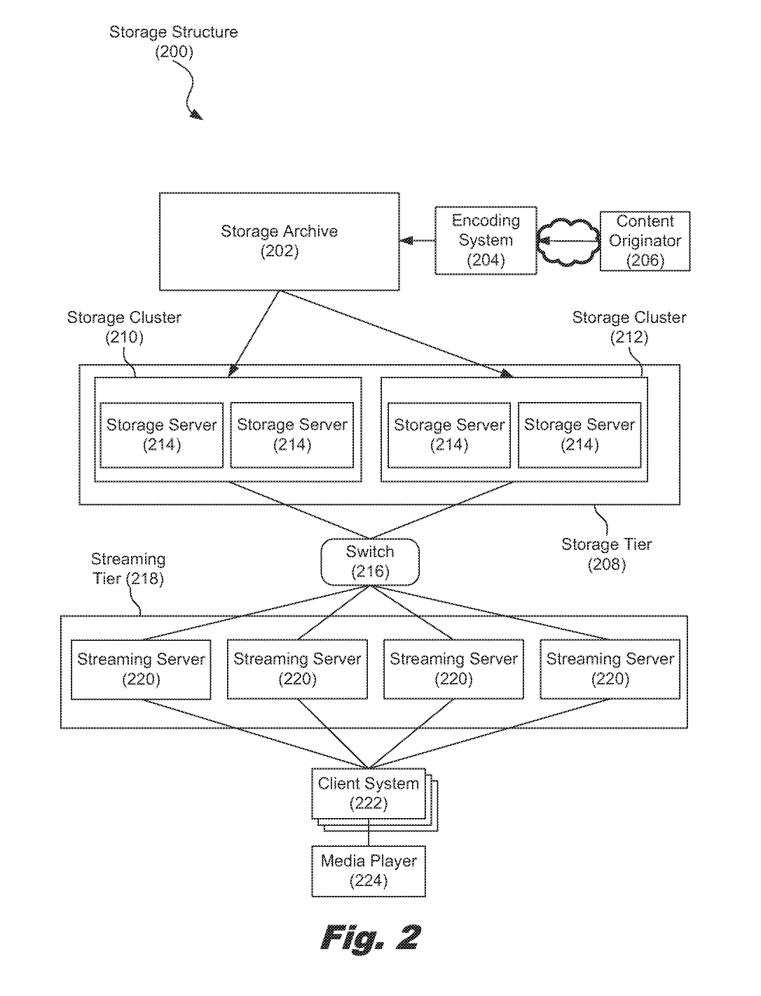

By way of example, FIG. 2 is a diagram showing an illustrative architecture (200) for data storage and streaming. The illustrative architecture (200) may include a storage archive (202), a storage tier (208) having multiple storage clusters (210, 212) each having multiple storage servers (214), and a streaming tier (218) including multiple streaming servers (220). As illustrated in FIG. 2, the exemplary data storage structure (200) may include an encoding system (204) disposed between a content originator (206) and the storage archive (202). Additionally, as illustrated in FIG. 2, a switch (216) is disposed between the storage tier (208) and the streaming tier (218). From the front streaming tier (218), a client system (222) hosting a media player (224) may access the content. Further details of the interaction and capabilities of the exemplary data storage structure (200) are provided below.

According to one example, the storage archive (202) may be used to store all media content available on a content distribution network. Content may be acquired from content originators (206) and encoded through an encoding system (204) to convert the media content to a desired format. The format used may be any format which will facilitate efficient streaming of the media content.

As illustrated, the content received in the storage archive (202) may be distributed to the storage tier (208). The storage tier (208) may include several storage clusters (210, 212). Each storage cluster may include a number of storage servers (214). Media content may be distributed across the available storage clusters. Each storage cluster may also have access to the storage archive (202) to obtain media content. According to one exemplary embodiment, content is mirrored across multiple storage servers (214) within a media cluster. In addition content may be mirrored across multiple clusters which are located at separate POPs.

FIG. 2 also illustrates the streaming tier (218), according to one exemplary embodiment. As illustrated, the streaming tier (218) may include a number of streaming servers (220). Each streaming server may have access to multiple storage clusters via a network switch (216). The streaming servers (220) may be able to retrieve and in turn serve media content from multiple storage clusters (210, 212). Client systems (222) will be able to receive streaming data from the streaming servers (220), in one embodiment, a client system (222) may receive data from multiple streaming servers to increase the download streaming rate of media content. The faster the download streaming rate, the higher quality the media content will be when played on a media player (224) on a client system (222).

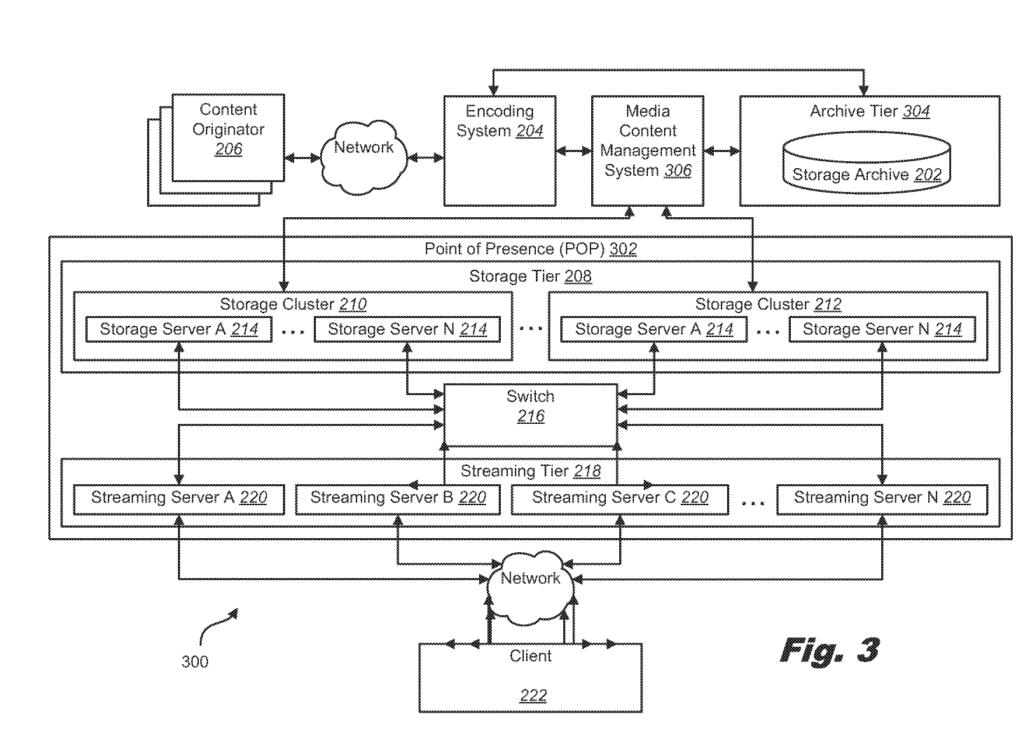

FIG. 3 further illustrates, with additional detail, the architecture 300) of the present exemplary system and method including a POP (302) with a storage tier (208) and a streaming tier (218), in this example, all content stored by the point of presence (302) is present on at least one home storage server (214) in the storage tier (208). Additionally, media content that is being currently streamed or for which there is a high anticipated demand (i.e., “the working set”) is replicated to one or more local disks on the streaming servers (220) of the streaming tier (218). The system makes the best effort to move working set files onto streaming servers (220). The system's ability to move the working set to the streaming tier (218) is limited by local disk space available on the streaming tier (218). A copy of all content ingested into the exemplary POP (302) is kept in the storage archive (202) in the archive tier (304).

Content is replicated to the storage tier (208) and streaming tier (208) under direction of the media content management system (306) based on replication rules. At least some of these replication rules may be specified by the content originator (206). Additionally or alternatively, general replication rules may be implemented by the system. The media content management system (306) may implement a computer-based data distribution module configured to analyze traffic statistics associated with each media content file and selectively cause the media content files to be distributed or replicated to the streaming tier based on the traffic statistics. According to one exemplary embodiment, a synchronization module component of the media content management system (306) is configured to use traffic statistics obtained from the streaming servers (220) to determine what content needs to be available in the streaming cache. While the streaming cache stored by the streaming servers (220) contains frequently accessed media, the media may also be readily available at the “home” location, as identified by the content ID or URL.

The exemplary system and architecture illustrated in FIGS. 2 and 3 remove traditional bottlenecks between streaming servers (220) and the disk clusters (210, 212) in a POP (302). For example, the media storage of the present exemplary system and method includes multi-tiered storage on storage (disc) clusters (210, 212) of the storage tier (208) and also the local disk cache on the streaming servers (220) of the streaming tier (218). Media store components in the media content management system (306) are responsible for dynamically replicating media content from the disk clusters (210, 212) of the storage tier (208) to the local caches in the streaming tier (218).

According to one example, the present exemplary system allows for a scalable storage repository. Specifically, the media storage architecture may be designed as a single logical content repository that is implemented across multiple disk clusters distributed across multiple network POPs (302). While the architecture may include multiple separate disk clusters, a content naming and storage scheme may allow the media content of the entire hierarchy to be viewed as a single large data store. The system can be scaled up easily by adding new disk clusters at the storage tier (208) of one or more POPs (302) and/or more streaming servers at the streaming tier (218) of one or more POPs (302).

Additionally, according to one exemplary embodiment, the present exemplary system may be configured to operate as a multi-tenant repository partitioned across multiple customer accounts. Specifically, when content from multiple content originators (206) is ingested into the present system, content for each content originator (206) may be kept separate from the content of other content originators (206). Storage quotas can then be applied on a per tenant basis.

While at a logical level the storage architecture functions as a single large repository, at a physical level the architecture is composed of multiple disk clusters (210, 212) that are distributed over multiple POPs (302). Consequently, in order to maintain streaming performance, content should be available on at least one home cluster (214) of the storage tier (208) at the POP (302) from which it is being streamed.

Because all content ingested into the media store is assigned a ‘Home’ cluster (210, 212) where the content is guaranteed to be always available, regardless of the amount of replication that occurs, any time a system component needs to fetch a specific content that is not available in a local cache or disk cluster (210, 212), it can fetch the file from its home disk cluster (210, 212) at its home POP (302). According to one example, the home cluster ID is part of the content name or URL so that the location of ‘Home’ can be efficiently determined by the system without any further lookup.

According to one example, the home cluster is assigned based on rules set up in the Media Content Management System (306) when an account is created for a content originator. All content for a content originator (306) may be horned on the same cluster. In the example where the home cluster for media content can be determined from a URL for that media content, the home cluster for that content may not be altered as doing so could result in the distribution and use of invalid media URLs. Even though the cluster ID is not altered, the physical location of the home cluster (210, 212) itself may, according to one exemplary embodiment, be moved anywhere within the architecture.

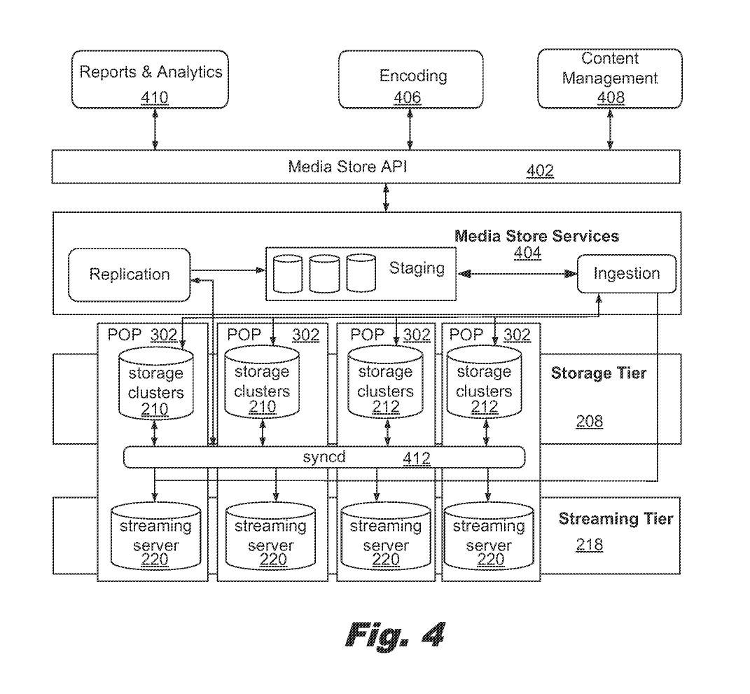

FIG. 4 illustrates a larger-scale view of the architecture (400) for storing and streaming content described in FIGS. 2-3. As shown in FIG. 4, a plurality of computer-implemented media store services (404) can be centrally consolidated and performed for multiple POPs (302) in the architecture (400). These services (404) include, but are not limited to, content ingestion (404), content staging (406), and content replication (408). For example, content ingestion, staging, and replication processes may be accessed and/or controlled through the API (402) using encoding or content management external calls (406, 408, respectively). Additionally, reports and analytics about any performance aspect of the architecture (400) may be accessed through the API (402) using appropriate API calls (410). The exemplary architecture (400) may interact with external processes through an Application Programming interface (API) (402). As part of the replication process, a computer-implemented synchronization module (412) may coordinate the replication of content from the storage clusters (210, 210) of individual POPs (302) to streaming servers (220) of the POPs (302).

According to one alternative exemplary embodiment of the present system and method, content replication by the synchronization module (412) is based on customer specific replication rules that support replication of content directly into the streaming tier caches. For example, usage and demand statistics may be gathered for specific media content files, and the media content files for which there is a high measured or perceived demand may be replicated along one or more of the streaming servers (220) to ensure a high-quality streaming experience to the end-user. For example, the synchronization module (412) may be configured to collect and analyze traffic statistics associated with individual media content files and selectively distribute the media content files on the streaming tier based on the traffic statistics.

Additionally, a media content originator or customer may choose some of the conditions by which content is replicated by the synchronization module (412). For example the media content originator may elect to place content that is expected to be in heavy demand or for which a particularly high-level quality of streaming is desired in the streaming tier. According to this exemplary embodiment, a content originator or customer may flag content as likely to have high demand. When this content is ingested, the media ingestor will recognize the content as likely to have high demand and will place the content in a home storage cluster and directly replicate the content to a number of streaming servers.

Storage Layout

According to one example, the media storage of the present architecture may be implemented as a set of file system folders or directories on the storage tier servers of the present system and method. Every cluster/storage server may have a base path where the media storage is mounted. Storage may, for example, be mounted according to the form of /www/M0002; where M0002 is a universal cluster ID that is used to mount storage on all servers. The cluster IDs are used and recognized across the entire architecture through the use of logical to file system partition mapping. Consequently, the software components of the present exemplary system are cluster agnostic.

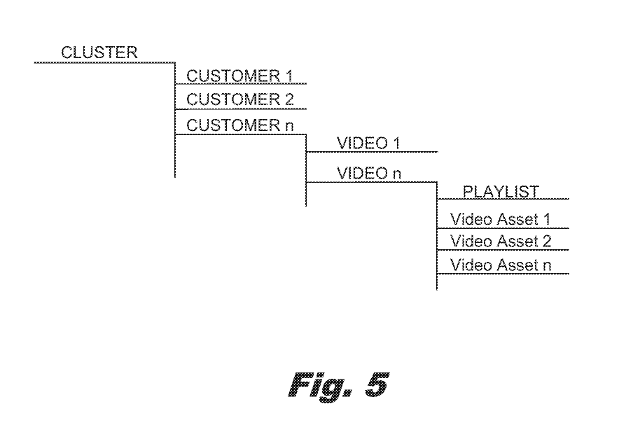

Referring now to FIG. 5, a storage layout according to one exemplary embodiment is illustrated. As shown in FIG. 5, on an exemplary storage cluster there is a separate directory for each customer (i.e., content originator). All content owned by a customer is placed in that customer's directory. Each customer directory may be named using a customer ID assigned to that particular customer.

FIG. 5 illustrates the organization of multiple video content files in this type of file system. As shown, each video (video 1, . . . video n) is placed in a directory of its own. The video directory is named using the video ID assigned to the video by the architecture during ingestion. A video may include a playlist file and multiple asset files for video, audio, sub-titles and so on.

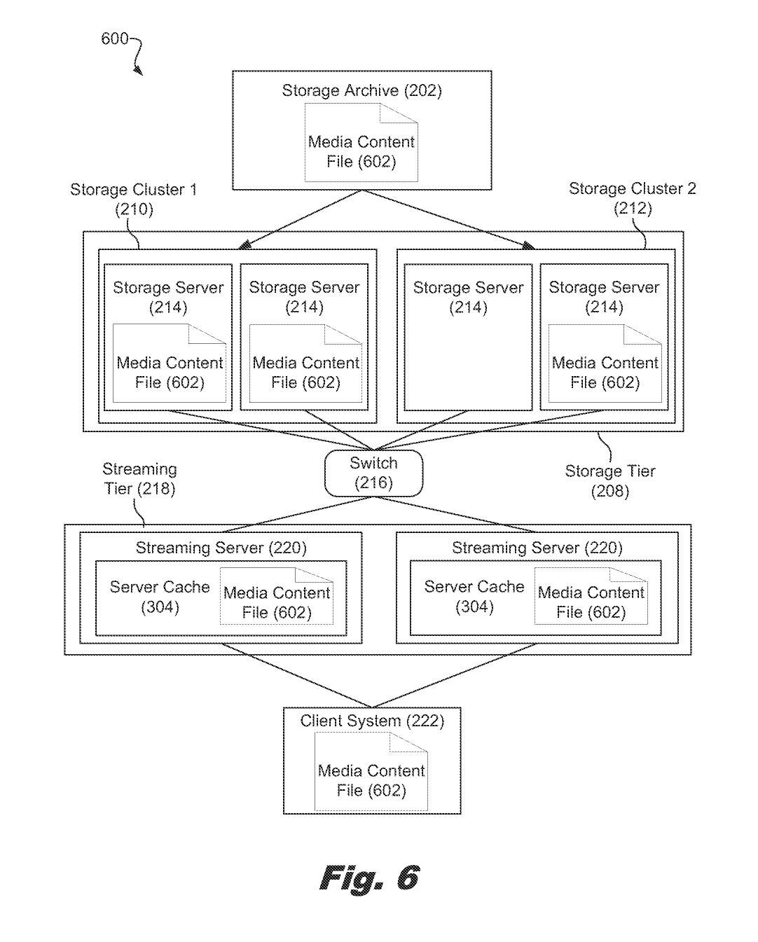

Returning now to FIG. 6, FIG. 6 is a diagram showing an illustrative media content file placement on an architecture (600) for storing and streaming media content according to the principles described herein. In the present example, a copy of each media content file (602) available from the architecture is stored in the storage archive (202). A particular media content file (602) may reside on some but not necessarily all of the storage servers (214). The degree to which a media content file (602) is mirrored may depend in part on its popularity. In one embodiment, a media content file (602) may have a “home” storage server on which it may always be available.

When a client system (222) desires to receive a stream of a particular media content file (602), a number of streaming servers may transfer the media content file from the storage tier (208), into the streaming tier (218). This may be done if the media content file (602) is not already stored on the streaming servers (220). Alternatively, the requested media content file (602) may be streamed to the client system (222) directly from the storage tier (212), particularly if the media content file (602) is not a popular file with high streaming demand.

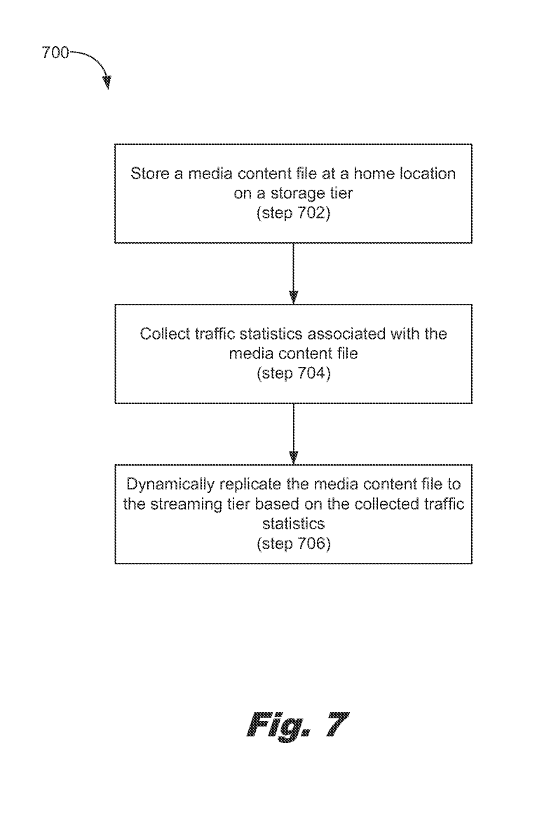

FIG. 7 is a flowchart showing an illustrative method (700) for storing media content on a data storage structure. According to one illustrative embodiment, a media content file is initially stored at a home location on a storage tier (step 702). The media content file may also be stored at an archive tier. The storage tier may include a number of storage clusters, each storage cluster having a number of storage servers or storage volumes configured to receive, store, and stream media content. Traffic statistics associated with the media content file may then be collected (step 704). These traffic statistics may include measured and anticipated demand for streaming the media content file or a file associated with the media content file. Based on the collected traffic statistics, the media content file is dynamically replicated (step 706) to a streaming tier based on the collected traffic statistics (step 708). In some examples, the media content file will only be replicated to one server and/or one POP at the streaming tier level based on a high demand for the media content file that is highly localized. Alternatively, the media content file may be replicated across multiple servers and POPs according to the collected traffic statistics associated with the media content file. According to this exemplary embodiment, the streaming tier may include a number of streaming servers configured to respond to get requests from consuming client systems. The streaming servers may be equipped to stream the media content file to a consuming client system much faster than the storage tier is able to stream the media content file to the same consuming client system. Thus, where the storage tier is optimized for storing high volumes of data, the streaming tier is optimized for fast streaming of content.

Media Content Distribution

As noted above, the present exemplary system utilizes a synchronization module to manage the distribution of media content between the different tiers. Specifically, according to one exemplary embodiment, the synchronization module is configured to use traffic statistics obtained from the streaming servers (220) to determine what content needs to be available in the streaming cache.

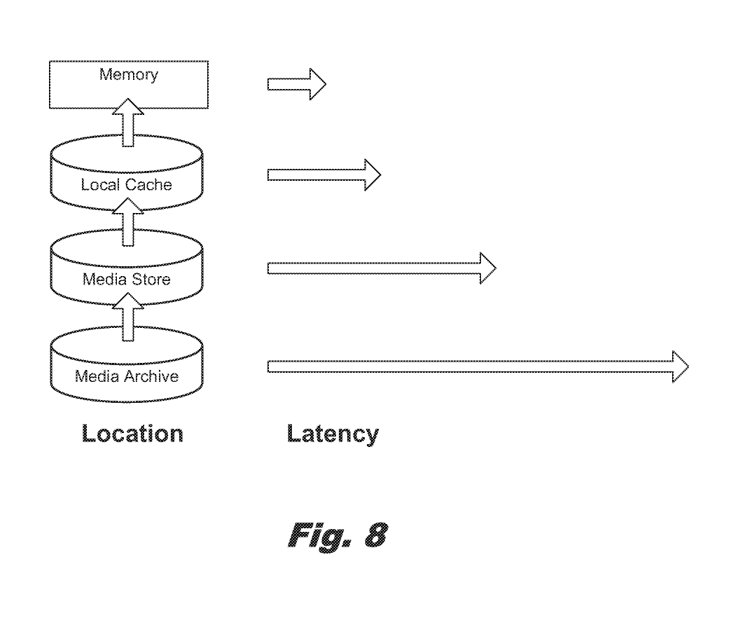

The synchronization module provides a number of efficiencies to the present exemplary system. Specifically, streaming performance is directly impacted by the time taken by the streaming servers to access content for streaming. As illustrated in FIG. 8, the time to access content is related to the location of the content within the system, with lowest latency for content that is cached in memory to the largest latency for content that is on the media archive.

According to one exemplary embodiment, overall system streaming performance is greatly improved if frequently accessed content is available on the streaming server's local disk from where it gets cached in memory by the file system. The synchronization module is responsible for moving content from disk cluster to cache in order to improve system streaming performance.

According to one exemplary embodiment, the present exemplary synchronization module includes an algorithm that is based on using streaming traffic heuristics to determine ideal candidate content files for placement in the cache. As noted below, streaming traffic data is collected by the streaming server as it receives requests for content.

More specifically, according to one example, each streaming server collects data on a) content requests successfully serviced and b) cache misses. The streaming server collects data on content requests successfully serviced by recording the URL and bytes returned for all requests that the server was able to successfully service. Similarly, each streaming server also keeps track of all requests for which it could not find content in its local disk cache, and had to fetch content from or redirect a request to the storage tier. This traffic data is recorded in an in-memory table by each streaming server and the in-memory table is periodically flushed to disk. Once data is flushed to disk it is picked up by the synchronization module for processing. By recording traffic statistics in memory for each streaming server, there is no significant impact to streaming performance. As such, this method of statistic collection and reporting is far more efficient than traditional methods, which use disk input/output operations and substantially interfere with streaming performance.

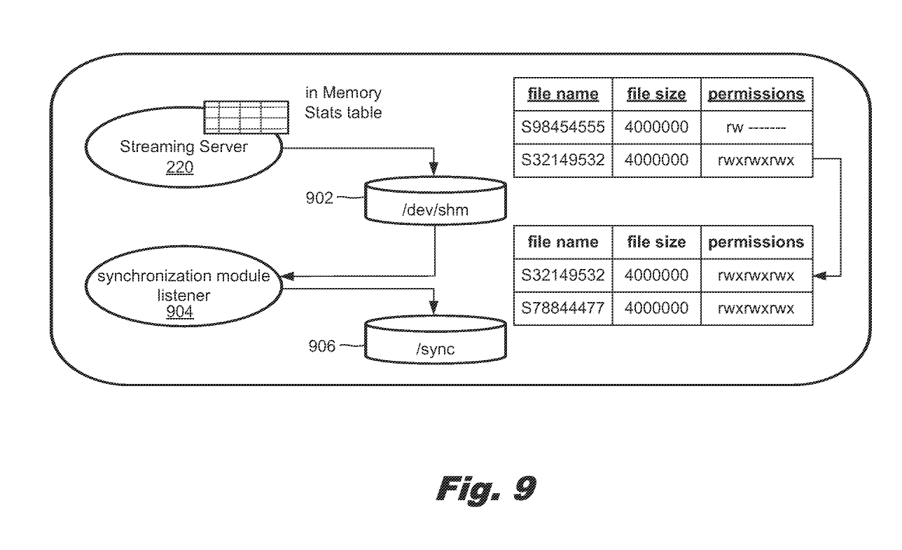

FIG. 9 illustrates the collection of streaming traffic statistics in a streaming server (220), according to one example of the principles described above. This functionality may occur in each of the streaming servers (220) of the architecture described in the present specification. As illustrated in FIG. 9, the in-memory table used by a streaming server (220) is a memory mapped file on a folder (902) of a local disk. A memory mapped file allows the streaming server to append content-specific traffic statistics to the file without using significant amounts of input/output resources. At the expiration of a periodic interval or when the pre-allocated memory for the memory mapped file is used up, whichever comes first, the streaming server (220) closes the file descriptor for the memory mapped file (keeping the memory mapped file in shared memory) and reallocates a new file descriptor for a new memory mapped file to save the next set of statistics.

Continuing with FIG. 9, a synchronization module listener subsystem (904) also forms a component of the present system and method. As illustrated in FIG. 9, the synchronization module listener subsystem (904) continuously polls the location (902) where the streaming server (220) writes the traffic statistic. The streaming server (202) and the synchronization module listener subsystem (904) use file permissions to synchronize their access to the traffic statistic files. As long as a file is in use by the streaming server (220) for traffic statistic collection, the file access permissions are set to “rw- --- ---”. When the streaming server (220) has filled and closed the file, the file access permissions are set to “rwx rwx rwx”. The streaming server (220) then opens a new file for traffic statistics collection.

When the synchronization module listener susbsystem (904) finds a stats file with file permissions set to “rwx rwx rwx” it immediately picks up the file and moves it over to the “/sync” folder (906) on the local disk. Traffic statistics files moved to the “/sync” folder (906) are processed later by the main synchronization module server. This scheme for collection of statistics and synchronization between the streaming server (220) and the synchronization module guarantees that the streaming server (220) and the synchronization module are loosely connected and that the synchronization module processing does not impact performance of the streaming server (220).

Synchronization Module Architecture

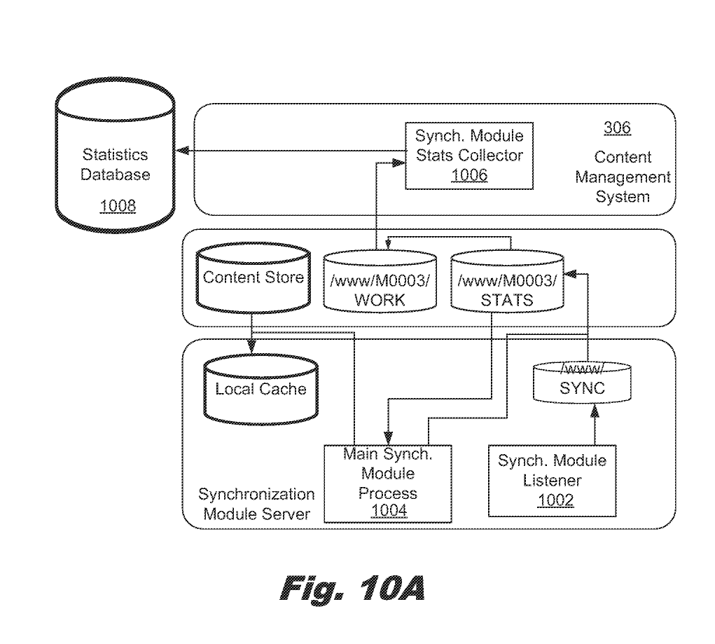

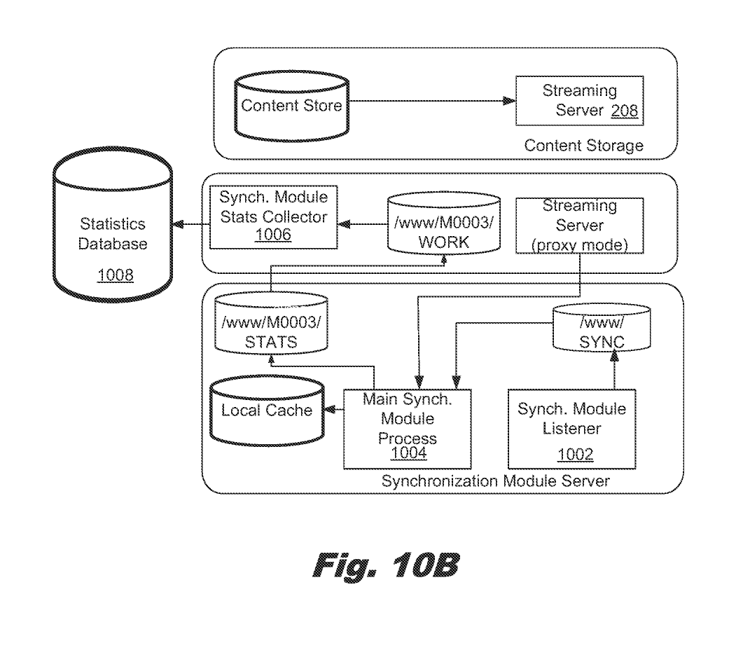

As illustrated in FIGS. 10A and 1013, the synchronization module may include three key components—the synchronization module listener subsystem (1002) which collects data from the streaming servers at the streaming tier (218); the main synchronization module process (1004) that is responsible for synchronization of content between the storage tier (208) and the streaming servers of the streaming tier (218); and the synchronization module collector process (1006) which parses collected streaming server traffic data for all of the streaming servers from the synchronization module (1004) for insertion into a comprehensive system-wide analytics database (1008). Replication decisions may be made on a local POP basis by a synchronization module sub-system and also on a global basis using the system-wide analytics database (1008), FIG. 10. A illustrates an exemplary synchronization module subsystem configuration to be used with a traditional disk array based memory system. In contrast, FIG. 10B illustrates an exemplary synchronization module content distribution module to be used with a storage server based system.

Synchronization Module Listener

According to one exemplary embodiment, the synchronization module listener subsystem (1002), which may in one embodiment run on the streaming server (220), keeps scanning the directory (e.g., /dev/shm) used by the streaming server (220) for traffic statistics files that the streaming server (220) has marked as ready for processing. In Unix/Linux systems, /dev/shm is a path used to access shared memory. Files created in dev/shm typically remain in RAM, which allows the synchronization module to access the statistical data much faster than if the statistical data were stored on a disk of the streaming server. The listener process frequently scans and moves traffic statistics files to its private processing folder, /www/sync, so that the /dev/shm file system does not fill up. Traffic statistics files collected in the /www/sync folder are then processed by the main synchronization module server.

Synchronization Module Collector

As illustrated in FIGS. 10A and 10B, a synchronization module collector (1006) parses streaming server (220) stats files and updates the database (1008) on the Content Management System (306) node with streaming server content-specific traffic statistics.

Synchronization Module Server

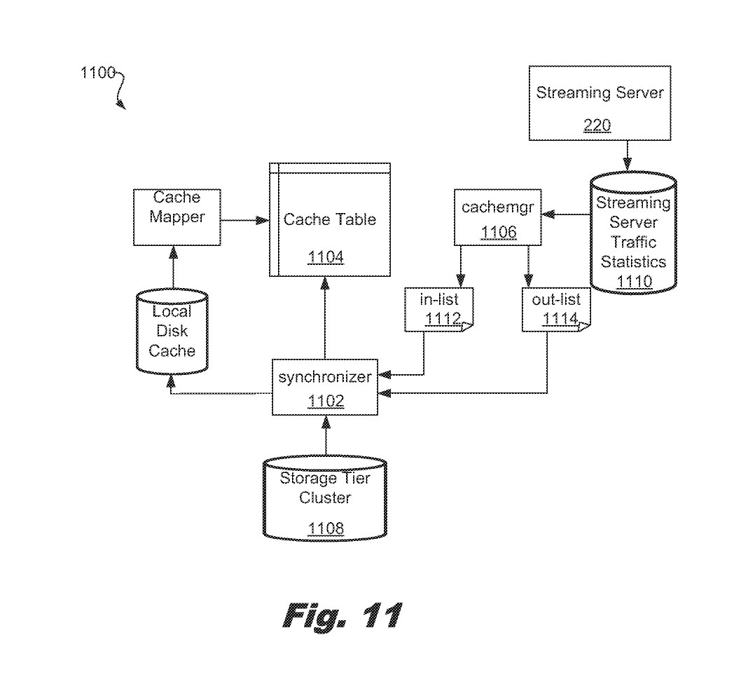

FIG. 11 is a block diagram illustrating the components of the synchronization module server, according to one exemplary embodiment. As illustrated in FIG. 11, the synchronization module server includes a processor or synchronizer (1102) that is in communication with a cache table (1104), a cache manager (1106), a storage tier cluster (1108), and a local disk cache (1110). According to one exemplary embodiment, the synchronization module server process does the main processing of the synchronization module sub-system. When the files collected in the /www/sync folder are processed by the main process server, the synchronization module parses streaming server (202) stats files to determine which content files should be moved into the streaming tier from the storage tier, based on the frequency with which they are requested.

Cache Table

Continuing with FIG. 11, at the core of the synchronization module process is a cache table (1104). According to one example, the cache table (1104) represents the media content files stored by the streaming server with their corresponding streaming statistics. For every content file in the streaming server (220) there is one entry in the cache table (1104). Each entry in the cache table (1104) also indicates the “hit rate” for the corresponding file. According to one exemplary embodiment, the hit rate is indicative of the popularity of the content the entry represents. According to this exemplary embodiment, content that is being requested and streamed by a lot of users will have a high hit rate, whereas, content that is requested and streamed less frequently will have a lower hit rate. Dynamically updating the cache table allows the synchronization module to selectively allocate the appropriate content to the streaming tier.

Cache Manager Module

The cache manager module (1106) (referred to in FIG. 11 as the ‘cachemgr’) of the synchronization module is configured to parse streaming server (220) traffic statistics (1110) and dynamically update the cache table (1104) based on the traffic statistics. Particularly, for each media content file that the streaming server stores, the cache manager module (1106) may update a corresponding ‘hit rate’ statistic. In one example, the cache manager module (1106) runs as an independent thread within the synchronization module process and periodically wakes up to process streaming server traffic statistics files. In an alternative embodiment, the cache manager module is constantly processing the streaming server traffic statistics files and updating the hit rates corresponding to the files in the streaming server.

Additionally, as shown in FIG. 11, the cache manager module (1106) may maintain two lists: the In-List (1112), which is a list of files that are candidates for replicating onto the streaming tier, and an Out-List (1114) which is a list of files which are stored by the streaming server (220) and are candidates for removal from the streaming server (220). According to this exemplary embodiment, when the cache manager module (1106) finds an entry in the streaming server (220) traffic statistics for a file that is not currently stored in the streaming server (220), it makes an entry for that file in the In-List (1112). If an entry already exists in the In-List (1112), the hit rate associated with that file's entry is updated. Similarly, the cache manager module (1106) also searches the cache table (1104) for those files that have the lowest hit rates. It then makes an entry for these files in the Out-List (1114). Out-List candidates may be sorted by file size. Files with the largest size are candidates for early removal.

According to this exemplary embodiment, the synchronizer module (1102), illustrated in FIG. 11 looks at the In-List (1112) sorted by hit rate. Entries in the In-List (1112) with the highest hit rate are moved to the streaming server (220) first. The synchronizer module (1102) runs as an independent thread within the synchronization module process and it periodically checks to see if there are any entries in the In-List (1112). When the synchronizer module (1102) finds an entry in the In-List (1112), it copies that file from the media storage tier to the streaming server (220). It then removes the entry from the In-List, makes a new entry for the file that was moved in the cache table (1104), and then continues to process other entries in the In-list (1112). While copying files to the streaming server (220), if the synchronizer (1102) finds that available space in the streaming server (220) is falling below set thresholds, it accesses the Out-List (1114) to see what files can be removed from streaming server (220) to free up space.

Cache Mapper

As illustrated in FIG. 11, the synchronizer (1102) is communicatively coupled through a local disk cache (1116) to a cache mapper (1118). According to one exemplary embodiment, the cache mapper module (1118) is responsible for synchronizing the cache table (1104) with the actual files in the streaming server (220). The cache mapper (1118) periodically does a directory lookup of the files stored by the streaming server (220) and then updates the cache table (1104). When the synchronization module is initiated, the cache mapper (1118) looks up the file system of content files stored by the streaming server (220) and builds the cache table (1104).

In sum, a data storage structure for a content distribution network may be set up in a way no as to provide horizontal scalability and increased efficiency. This is done by having a tiered data storage structure. The data storage structure may include an archive tier configured to store media content, a storage tier connected to archive tier, and a streaming tier connected to the storage tier. The streaming tier may be configured to stream said media content to client systems. Additionally, the inclusion of a media content distribution system to the data storage structure assures that media content will be efficiently routed to the best available location on the structure.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A system for storing content available for streaming, the system comprising:
a storage tier comprising a plurality of storage clusters each of said storage clusters comprising at least one server, said storage clusters collectively storing a plurality of media content files;
a streaming tier communicatively connected to said storage tier, said streaming tier comprising a plurality of streaming servers, said streaming tier being configured to stream data over a network faster than said storage tier is able to stream said data over said network; and
a computer-implemented synchronization module configured to analyze traffic statistics associated with a said media content file stored on said storage tier and selectively replicate said media content file on said streaming tier based on said traffic statistics.

2. The system of claim 1, wherein said traffic statistics comprise a measured demand for said media content file.

3. The system of claim 1, wherein said traffic statistics comprise an anticipated demand for said media content file.

4. The system of claim 1, wherein said synchronization module replicates said media content file on said streaming tier in proportion to a demand for said media content file derived from said traffic statistics.

5. The system of claim 1, wherein said traffic statistics are measured by said streaming servers in said streaming tier.

6. The system of claim 5, wherein said traffic statistics comprise requests for said media content file tracked by a said streaming server.

7. The system of claim 6, wherein said traffic statistics comprise a number of times the said streaming server has successfully streamed said media content file to a requesting client.

8. The system of claim 6, wherein said traffic statistics comprise a number of times the said streaming server was unable to fulfill a request for said media content file from a client.

9. The system of claim 5, wherein said synchronization module comprises a listener subsystem configured to retrieve said traffic statistics measured by the said streaming server.

10. The system of claim 9, wherein said listener subsystem is configured to poll a storage location in said streaming server to retrieve said traffic statistics measured by the said streaming server.

11. The system of claim 10, wherein said listener subsystem is configured to poll said location of said recorded statistics after the expiration of a predefined period of time.

12. The system of claim 10, wherein said listener subsystem is configured to poll said location of said recorded statistics continually.

13. The system of claim 1, wherein said listener subsystem is configured to retrieve said traffic statistics from each of said streaming servers in said streaming tier.

14. The system of claim 1, wherein said synchronization module further comprises a collector module coupled to each of said streaming servers in said streaming tier, said collector module being configured to parse said traffic statistics as measured by each of said streaming servers and update a statistics database associated with said synchronization module with data representative of said traffic statistics measured by each of said streaming servers.

15. The system of claim 1, wherein said synchronization module is further configured to implement:
a cache table configured to track each media content file stored by a said streaming server together with traffic statistics associated with each said media content file stored by said streaming server; and
a cache manager module configured to continuously update said cache table.

16. The system of claim 1, wherein said synchronization module is further configured to remove said media content file from a said streaming server based on said traffic statistics associated with said media content file.

17. A data storage structure for storing media content available for streaming, said structure comprising:
said storage tier comprising a plurality of storage clusters each of said storage clusters comprising at least one server, said storage clusters collectively storing a plurality of media content files;
a streaming tier communicatively connected to said storage tier, said streaming tier comprising a plurality of streaming servers, each of said streaming servers being configured to store at least one said media content file stored by said storage tier and stream said media content file over a network at a rate that is faster than said storage tier is able to stream said media content file over said network, each of said streaming servers being further configured to record traffic statistics associated with said streaming of said at least one media content file; and
a computer-implemented synchronization module communicatively coupled to said streaming servers, said synchronization module being configured to analyze said traffic statistics recorded by said streaming servers and dynamically replicate media content files stored by said storage tier onto said streaming servers based on said traffic statistics.

18. The system of claim 17, wherein said synchronization module is further configured to remove media content files from at least one of said streaming servers based on said traffic statistics.

19. A method, comprising:
storing a plurality of media content files on a storage tier, said storage tier comprising a plurality of storage clusters, each of said storage cluster comprising at least one server;
storing at least one of said media content files on a streaming server of a streaming tier, said streaming server being able to stream said at least one of said media content files over a network at a rate faster than said storage tier is able to stream said at least one of said media content files over said network;
tracking streaming activity of said at least one of said media content files in said streaming server; and
selectively replicating said media content files on said streaming server based on said tracked streaming activity.

20. The method of claim 19, wherein said tracked streaming activity comprises a number of requests received at said streaming server for said at least one of said media content files.
